(19) United States
(12) Patent Application Publication
(10) Pub. No.: US 2013/0100652 A1
(43) Pub. Date: Apr. 25, 2013

(54) OMNIDIRECTIONAL PORTABLE LIGHT

(71) Applicant: Marylee Guinon, Walnut Creek, CA (US)

(72) Inventor: Marylee Guinon, Walnut Creek, CA (US)

(73) Assignee: MARYLEE GUINON, LLC, Walnut Creek, CA (US)

(21) Appl. No.: 13/459,132

(22) Filed: Apr. 28, 2012

Related U.S. Application Data
(60) Provisional application No. 61/548,730, filed on Oct. 19, 2011.

(51) Int. Cl. F21L 4/02; F21L 4/00

(52) U.S. Cl. 362/184; 362/157

(57) ABSTRACT

A portable lighting device is disclosed. The device has a translucent housing which contains a light-emitting element, a battery, and a motion-responsive switch. When the light-emitting element is activated, light is emitted in all directions, through the translucent housing. The portable lighting device can be used in a hand-held container, such as a purse, a briefcase, or a backpack.

### CROSS-REFERENCE TO RELATED APPLICATIONS

This application claims priority to U.S. Provisional Patent Application 61/548730, filed Oct. 19, 2011, which is incorporated by reference herein.

### BACKGROUND OF THE INVENTION

### Field of the Invention

This invention relates generally to a portable lighting device, and, more specifically, to a compact, motion-activated, portable lighting device that emit light in all directions.

It can be difficult to find desired items in a hand-held container, such as a purse, hand bag, gym bag, or briefcase, especially when there is no external source of light. This has been addressed in the past, perhaps, by carrying a flashlight, or affixing a flashlight to the hand-held container. But, the flashlight must still be found before it can be turned on, and, even then, a flashlight shines light in just a single direction. It can require extensive manipulation of such a light to examine the entire contents of the hand-held container, in order to find the desired items.

While there are numerous published references that describe various types of illuminating devices, and bags or purses having lighting systems, none has offered a device that can be activated by shaking, and, once activated, can illuminate the entire interior of a container.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1A is a schematic illustration of an omnidirectional portable light, according to an embodiment of the invention.

FIG. 1B is a schematic illustration of an omnidirectional portable light, showing another possible arrangement for one of the elements, according to an embodiment of the invention.

FIG. 2 is a schematic drawing of an omnidirectional portable light in an illuminated state, according to an embodiment of the invention.

FIG. 3 is a perspective view of an omnidirectional portable light, according to an exemplary embodiment of the invention

### SUMMARY

An omnidirectional, portable lighting device has a light-emitter, a power source, and a motion-responsive switch, all in electrical communication with one another. The motion-responsive switch is configured to control power flowing between the power source and the light-emitter. A wholly translucent housing contains the light-emitter, the power source, and the motion-responsive switch. In some arrangements, the portable lighting device also has a manually-operated switch on the exterior of the translucent housing, which can be used to override the motion-responsive switch. In one arrangement, there is also a fitting attached to the exterior of the translucent housing. The fitting can be used to connect the device to exterior objects.

### DETAILED DESCRIPTION

The embodiments of the invention are illustrated in the context of a portable illuminator for a container, such as a hand-held container. The skilled artisan will readily appreciate, however, that the materials and methods disclosed herein will have application in a number of other contexts where instant illumination is desirable, particularly where illumination in all directions is important. Examples of containers in which such an illuminator can find use include, but are not limited to purses, hand bags, gym bags, briefcases, diaper bags, backpacks, motorcycle panniers, and knitting bags.

These and other objects and advantages of the present invention will become more fully apparent from the following description taken in conjunction with the accompanying drawings.

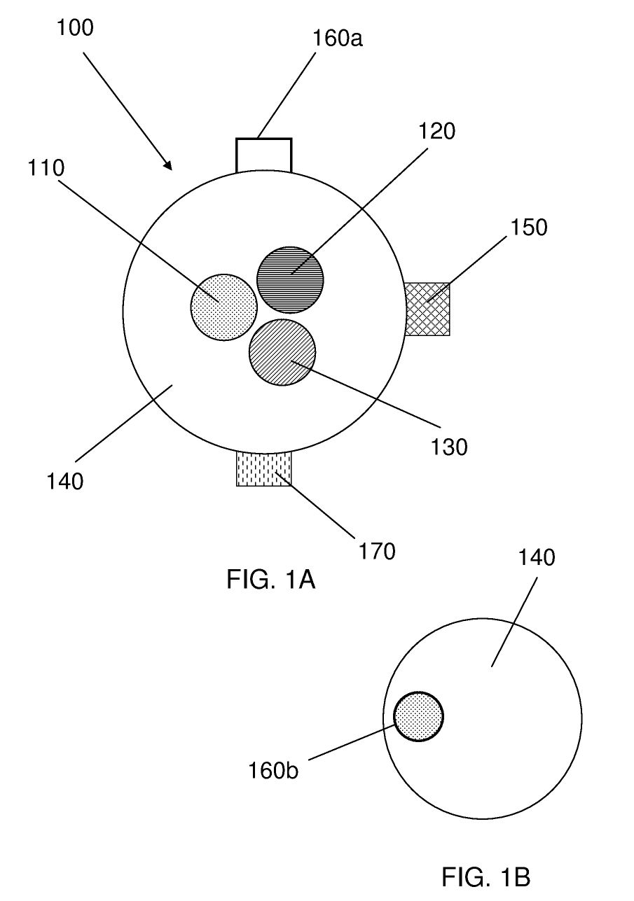

The basic components of an omnidirectional portable light 100 are shown in the schematic illustration in FIG. 1A. There is a light-emitting component 110, a power source 120, and a motion-responsive switch 130. The light emitting component 110 is in electrical communication with the motion-responsive switch 130, which is electrical communication with the power source 120. In this way power can flow from the power source 120 to the light emitting component 110 when the switch 130 is in an “on” position. The light-emitting component 110 can be any electrical element that emits light when activated by electrical current. Examples of such components include light-emitting diodes, incandescent bulbs, and halogen bulbs. In one arrangement, the light-emitting component 110 is a light-emitting diode (LED). The power source 120 can be a battery, such as a primary battery or a secondary battery. Embodiments that include a secondary battery also include a means (not shown) to recharge such a battery, such as a fitting to connect the secondary battery to an external power source, or a solar cell.

The motion-responsive switch 140 assumes an “on” position, that is, it allows current to flow from the power source 120 to the light-emitting component 110, turning on the illumination, when it is shaken. After a preset period of illumination time, the motion-responsive switch 140 assumes an “off” position, that is, it prevents current flow from the power source 120 to the light-emitting component 110, turning off the illumination. In one arrangement, if the motion-responsive switch 140 is shaken again during the preset period of illumination time, there is no addition effect. The switch still assumes an “off” position after the preset period of time. In another arrangement, if the motion-responsive switch 140 is shaken again during the preset period of illumination time, the preset period of illumination is extended. In one arrangement, the preset period of illumination time is between about 5 seconds and 5 minutes. In another arrangement, the preset period of illumination time is between about 15 seconds and 1 minute. In yet another arrangement, the preset period of illumination time is about 15 seconds. In yet another embodiment, the illumination time can be preset by the user to any length of time desired. This can be done through an additional switch (not shown) with various time length options. In arrangement, there is a port (not shown) on the light 100, through which the light 100 can be connected to an exterior control system, and the length of time can be set with the exterior control system. When the motion-responsive switch 140 is in an “off” position, it can assume an “on” position whenever it is shaken (unless it has been inactivated by a manual switch as described below).

The omnidirectional portable light offers particular advantages. When trying to find something in a dark container, it can be very difficult to first find a flashlight, turn it on, and then hold it in one hand, leaving only one free hand, in order to search in the container to find a desired object. With the omnidirectional light disclosed here, if the light is already in the container, one can shake the container, turning the light on, and then use two hands to search for a desired object. In addition, the omnidirectional portable light shines light in all directions without having to wave a flashlight around to illuminate different parts of the container. Furthermore, if the omnidirectional light is at the bottom of the container, it provides back lighting for the objects in the container, making them easy to identify. Thus, is fast and easy to find objects in a container that has within it an omnidirectional portable light as disclosed herein.

The light-emitting component 110, the power source 120, and the motion-responsive switch 130 are contained within a housing 140. The housing 140 is wholly translucent, that is, it is translucent in its entirety, and it can allow the emission of light in every direction. “Translucent” is used herein to mean, “transmitting light with some scattering or diffusion.” In one embodiment of the invention, the translucent housing 140 transmits light with lots of scattering and diffusion, thus making it difficult to see distinct components within. In another embodiment, the translucent housing 140 is almost clear with very little scattering or diffusion. In one arrangement, the translucent housing is roughened to aid in diffusing the light from the light-emitting component 110. The roughness can added by abrasion or by including very many small, rough features on the housing. The roughness can be either on the inside of the housing 140 or on the outside of the housing 140. The roughness helps to increase the diffusion of the light, and may be especially useful in the regions adjacent to the light-emitting component 110, where illumination may be most bright. In one embodiment of the invention, the light-emitting element is adjacent to the housing at both the front and the back of the portable light, and the housing has roughened regions adjacent to the light-emitting element at both the front and the back of the housing.

The housing 140 can be made of any material that is translucent and can contain the elements described herein. In one arrangement, the housing 140 is rigid. Examples of materials that can be used for a rigid housing include, but are not limited to, glass, and translucent, hard plastics, such as polycarbonate, polystyrene, high density polyethylene, acrylic, polysulfone, and poly(methyl methacrylate), also known as Plexiglass. In another arrangement, the housing 140 is flexible. Examples of materials that can be used for a flexible housing include, but are not limited to, translucent, flexible plastics, such as low density polyethylene, polytetrafluoroethylene, some ethylene copolymers, and vinyl. In one embodiment of the invention, the housing is made of poly(methyl methacrylate).

The housing can have any of a variety of shapes and colors. It should not be construed that the round or spherical shape shown in the schematic drawing in FIG. 1A are preferred shapes. Possible novelty shapes for the housing include, but are not limited to, any one of gemstones, birthstones, zodiac symbols, astronomical bodies, animals, flowers, shells, numbers, letters, hearts, sports equipment, foods, beverage containers, logos, various holiday, spiritual, and cultural symbols, and any geometric solid. There is no particular limitation as to the shape of the housing. Colors for the housing 140 include, but are not limited to, white, red, blue, yellow, green, purple, orange, amber, grey, and combinations thereof, as long as the colored housing is translucent. In one embodiment of the invention, the housing 140 is sealed as a single solid mass. In another embodiment of the invention, the housing 140 can be opened to gain access to internal components, such the light-emitting component 110, the power source 120, and the motion-responsive switch 130. In one arrangement, the housing 140 is configured to be water resistant so that water cannot enter the housing even when immersed in water at a depth of 10 cm for 1 hour, the same standard as is used for water-resistant watches.

In one embodiment of the invention, omnidirectional portable light has an external switch 150 that is operated manually. When the external switch 150 is in the “on” position, the portable light 100 functions are determined by the motion-responsive switch 140. When the external switch 150 is in the “off” position, the motion-responsive switch 140 is overridden, and the portable light 100 will not illuminate in response to motion. The external switch 150 is an especially useful feature when unplanned illumination can be problematic, as in a theater or a darkroom. In another arrangement, the external switch 150 has a third position that overrides the motion-responsive switch 140 to leave the portable light 100 illuminated until the external switch setting is changed.

In another embodiment of the invention, there is a fitting 160a that is attached to the exterior of the housing 140. The fitting 160a is provided so that the device 100 can be connected to exterior elements or objects. In another arrangement, as shown in FIG. 1B a fitting 160b is integral to the translucent housing, that is, it is contained within the housing 140, perhaps as a hole in the housing 140, rather than being attached to the exterior of the housing 140. Examples of elements that it might be useful to connect to the device 100 include, but are not limited to, a container, such as purse, hand bag, gym bag, or briefcase, a set of keys, or an identification card.

In another embodiment of the invention, there is a timing switch 170 on the exterior of the housing 140. The timing switch 170 can be used to set the period of illumination time for which the motion-responsive switch 130 remains in the “on” position once it is activated. In one arrangement, the period of time can be between about 5 seconds and 5 minutes. In another arrangement, the period of time can be between about 15 seconds and 1 minute. In yet another arrangement, the period of time can be of any length as desired by the user.

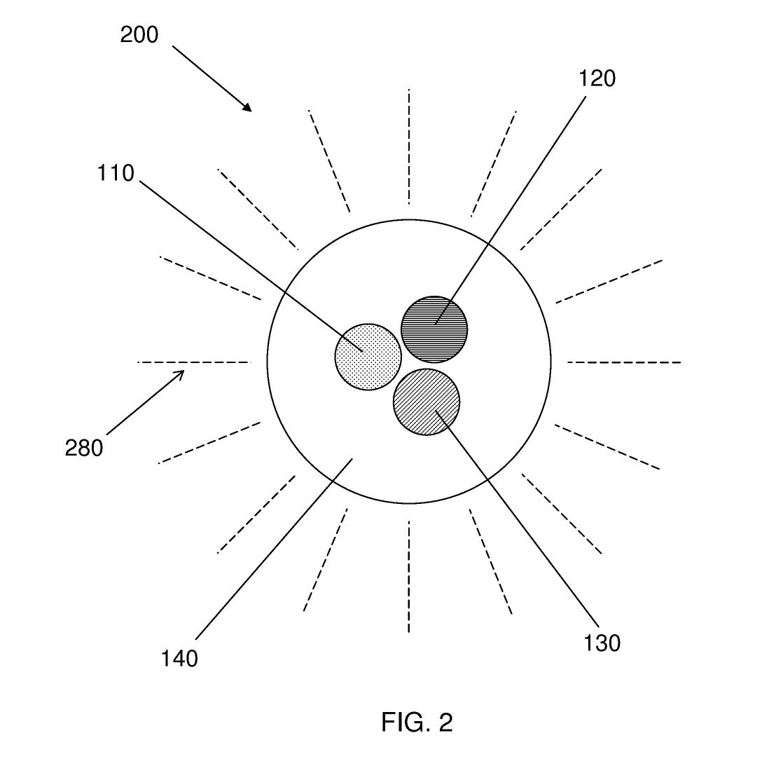

FIG. 2 is a schematic drawing of an omnidirectional portable light 200, according to an embodiment of the invention. Some basic elements of the light 200 are shown. There is a light-emitting component 110, a power source 120, and a motion-responsive switch 130, all in electrical communication with one another. The light-emitting component 110, the power source 120, and the motion-responsive switch 130 are contained within a housing 140. Further details about the elements 110, 120, 130, 140 are described above. FIG. 2 shows the portable light 200 in an illuminated state. Rays of light 280 extend from all surfaces of the light 200, that is, light is emitted in all directions—the light is omnidirectional. Althoug it cannot be shown in the schematic drawing, it should be understood that there are additional rays of light extending both forward and backward in all directions out of the plane of the page. In one embodiment of the invention, omnidirectional means that light is emitted from more than 80% of the housing 140. In another embodiment, omnidirectional means that light is emitted from more than 90% of the housing 140. In yet another embodiment, omnidirectional means that light is emitted from essentially 100% of the housing. In one arrangement, the light emitted from the housing 140 has the same intensity in all directions. In another arrangement, the light emitted from the housing 140 does not have the same intensity in all directions.

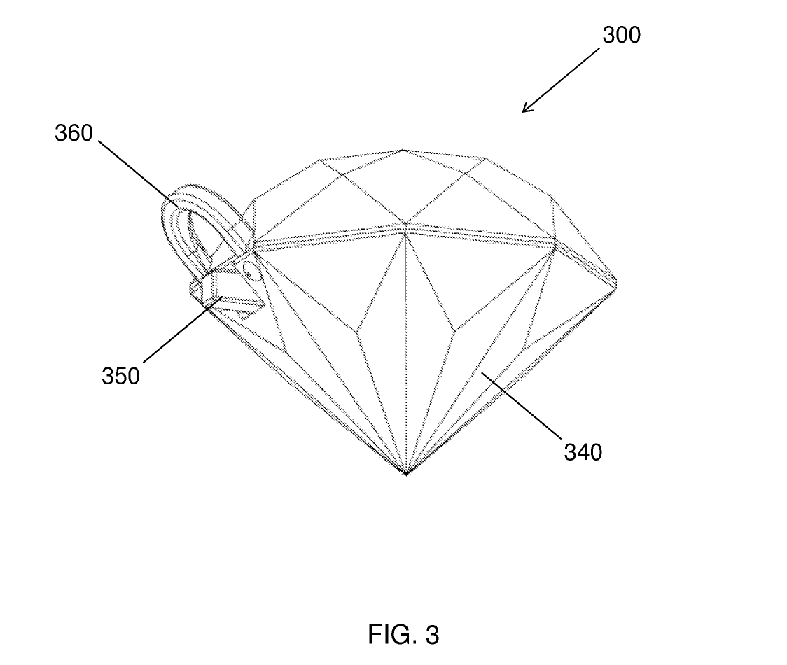

A perspective drawing of the exterior of an omnidirectional, portable light 300 is shown in FIG. 3, in an exemplary embodiment of the invention. The light 300 has a housing 340 that contains a light-emitting component (not shown), a power source (not shown), and a motion-responsive switch (not shown), in electrical communication with one another, as described above. Attached to the housing 340 is a fitting 360 that can be used to connect the light 300 to external elements (not shown). There is also an external switch 350 that can be used to override the motion-responsive switch when desired, as described above.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. An omnidirectional portable lighting device, comprising:
a first element comprising a light-emitter;
a second element comprising a power source in electrical communication with the first element;
a third element comprising a motion-responsive switch in electrical communication with both the first element and the second element, the switch configured to control power flowing between the second element and the first element; and
a wholly translucent housing that contains the first, second and third elements.

2. The device of claim 1 wherein the light emitter comprises one or more emitters selected from the group consisting of light-emitting diodes, incandescent bulbs, and halogen bulbs.

3. The device of claim 1 wherein the power source comprises a battery.

4. The device of claim 1 wherein the motion-responsive switch is configured to assume an “on” position when it is shaken.

5. The device of claim 1 wherein the motion-responsive switch is configured to assume an “off” position about 15 seconds after assuming an “on” position.

6. The device of claim 1 wherein the motion-responsive switch is configured to assume an “off” position between about 5 seconds and 5 minutes after assuming an “on” position.

7. The device of claim 6, further comprising a means by which the period of time can be selected by the user.

8. The device of claim 1 wherein the translucent housing comprises one or more colors selected from the group consisting of white, red, blue, yellow, green, purple, orange, amber, grey, and combinations thereof.

9. The device of claim 1 wherein the translucent housing is a sealed housing.

10. The device of claim 1 wherein the translucent housing is a water-resistant housing.

11. The device of claim 1 wherein at least a portion of the translucent housing comprises a rough region, on either the inside or the outside of the housing.

12. The device of claim 1 wherein the translucent housing comprises a novelty shape.

13. The device of claim 1 wherein the translucent housing is configured to pass light through in all directions when the motion-responsive switch is in the on position.

14. The device of claim 1 wherein the translucent housing is configured to pass light through in 90% of directions when the motion-responsive switch is in the on position.

15. The device of claim 1 wherein the translucent housing is configured to pass light through in 80% of directions when the motion-responsive switch is in the on position.

16. The device of claim 1, further comprising a manually-operated switch on the exterior of the translucent housing, the manually-operated switch configured to override the motion-responsive switch.

17. The device of claim 1, further comprising a fitting attached to the exterior of the translucent housing, the fitting configured to provide a means by which the device can be connected to exterior objects.

18. The device of claim 1, further comprising a fitting wherein the fitting is integral to the translucent housing.

19. An omnidirectional portable lighting device, comprising:
a sealed, wholly translucent housing that contains;
a light-emitting diode;
a battery in electrical communication with the light-emitting diode;
a motion-responsive switch in electrical communication with both the light-emitting diode and the battery, the switch configured to control power flowing between the battery and the light-emitting diode.

20. The device of claim 19 wherein the lighting device is configured to emit light in all directions when the power is on.

21. The device of claim 19 further comprising a manually-operated switch on the exterior of the housing, the manually operated switch configured to activate and inactivate the motion-responsive switch.
